(19) United States
(12) Patent Application Publication
(10) Pub. No.: US 2026/0316364 A1
(43) Pub. Date: Oct. 15, 2026

(54) METHOD FOR MANUFACTURING A BOARD OR SHEET MATERIAL

(71) Applicant: UNILIN, BV, Wielsbeke (BE)

(72) Inventor: Wim SPRIET, Wielsbeke (BE)

(21) Appl. No.: 19/485,904

(22) PCT Filed: Jun. 5, 2024
(86) PCT No.: PCT/IB2024/055483

§ 371 Date: Nov. 19, 2025

Related U.S. Application Data
(60) Provisional application No. 63/506,602, filed on Jun. 7, 2023.

(51) Int. Cl. B29C 48/00; B29C 48/07; B29K 27/06; B29K 105/00; B29K 105/16; B29K 105/26

(52) U.S. Cl. CPC B29C 48/022; B29C 48/07; B29K 2027/06; B29K 2105/0038; B29K 2105/0044; B29K 2105/16; B29K 2105/26

(57) ABSTRACT

A method for manufacturing a board or sheet material, where the board or sheet includes at least a layer of polyvinyl chloride with filler material. The method involves at least these steps: the step of blending a PVC composition; the step of extruding the PVC composition using an extruder with at least one screw and a slot nozzle die connected to the extruder's outlet. During the blending step, at least a first substep occurs, creating a primary blend of PVC and a first set of additives. This primary blend is either free of filler material or contains 10 wt % or less of filler. Then, at least a second substep occurs, producing a secondary blend that includes the primary blend, a second set of additives, and a portion of filler material. The PVC composition includes or is made entirely of this secondary blend.

The present invention relates to a method for manufacturing a board or sheet material. In particular the present invention relates to a method for manufacturing such board or sheet material that at least comprises a layer of polyvinyl chloride comprising filler material.

It is known, for example from WO 2019/086,566, to use such board or sheet material as a substrate layer of a decorative panel, such as a floor panel. Herein the substrate layer may be provided with a decorative top layer for example comprising a printed pattern. The method disclosed in WO '566 comprises the step of compounding a PVC composition and the step of extruding said PVC composition using an extruder, and a slot nozzle die linked to the outlet of said extruder. In the compounding step firstly a primary blend of PVC and a set of additives is created in a hot-cold mixer, wherein said primary blend initially may comprise 30% of the filler material. In the cooling down the remainder of the filler material is added to the primary blend, and this mixture then forms the PVC composition to be extruded. Compounding the PVC composition as disclosed in WO 566 may lead to high wear on the extruder and a suboptimal extrusion speed.

The present invention in the first place aims at providing an alternative method of manufacturing board or sheet material, wherein, in accordance with preferred embodiments, solutions are offered for one or more of the problems with the methods form the state of the art.

With the above goal, the present invention, in accordance with its first independent aspect is a method for manufacturing a board or sheet material, wherein said board or sheet material at least comprises a layer of polyvinyl chloride comprising filler material, wherein said method comprises at least the following steps:
the step of compounding a PVC composition;
the step of extruding said PVC composition using an extruder having at least one screw, and a slot nozzle die linked to the outlet of said extruder;
   with as a characteristic that said step of compounding comprises at least a first substep wherein a primary blend of PVC and a first set of additives is created, wherein said primary blend is free of filler material, or, wherein said primary blend comprises 20 wt % or less, or even 10 wt % or less, of said filler material, and, at least a second substep wherein a secondary blend is created comprising at least said primary blend, a second set of additives and a portion of said filler material, wherein said PVC composition comprises or consists of said secondary blend. The inventor has found that a two substep compounding may lead to a denser PVC composition which has less wear on the extruder screw. The denser PVC composition in itself may lead to a higher extrusion speed, as expressed in kilograms per hour. Because no or only a minimal amount of filler material is available in the primary blend, the first set of additives may optimally be blended with the PVC and the filler material will not or only minimally take up additives that are meant to alter the properties of the PVC phase.

The first set of additives is preferably limited to, or mainly made up of, additives that alter the properties of the PVC phase, while the second set of additives is preferably limited to, or mainly made up of, additives that enhance the mixing or coupling of the filler material into the PVC phase.

Preferably, said first set of additives comprises at least an impact modifier and/or a foaming agent, such as azodicarbonamide.

Preferably, said second set of additives comprises at least stabilizer and/or a wax. The stabilizer and/or wax may contact and/or wet the filler material. This leads to a better wetting and the bulk density of the obtained secondary blend may be higher. Because of the higher density of the secondary blend, which may be equal to, or form the largest portion of, said PVC composition to be extruded, less compression is needed in the extruder. This in itself may lead to less wear on the extruder barrel and screw, as well as to a higher extruder speed.

Preferably, said primary blend and said secondary blend are created in a hot-and-cold mixer. Preferably, said primary blend is created in a first hot-and-cold-mixer, while said secondary blend is created in a separate second hot-and-cold-mixer.

Hot-and-cold-mixers are known in the art of PVC compounding. A hot-and-cold-mixer is a batch mixer that may comprise a closed chamber, a motor-driven rotor, and a heating and cooling system to adjust the temperature of the mixing chamber as needed.

The present invention may limit the need of energy to efficiently mix the primary and/or secondary blend by means of the motor-driven rotor in said first and/or second hot-and-cold mixer.

Preferably, said PVC composition and/or said secondary blend comprises 50 to 90 wt % of filler material. It is especially with highly filled PVC materials that an enhanced management of extruder wear and output is of high interest. Due to the potential enhanced wetting of the filler material obtained in adding said filler material mainly in the secondary blend, the higher range of filler content in said PVC composition and/or in said secondary blend, e.g. 70 to 90 wt %, is easier attainable.

Preferably, said filler material comprises calcium carbonate and/or talcum. The use of talcum may be beneficial for the dimensional stability of the resulting board or sheet material and/or may function as a kicker for foaming, in the case where a foaming agent is used, for example in said first set of additives. Preferably, said filler material comprises 1 to 15 wt % of talcum, e.g. about 7 wt %, while the remaining portion of said filler material comprises 80 to 99 wt % of calcium carbonate, e.g. about 93wt %.

Preferably said filler material, more particularly said calcium carbonate in said filler material, is free of coating, or, alternatively coated with a stearate, at the moment of adding to said secondary blend. The inventor has found that adding the filler material mainly in said secondary blend, and the obtainable enhanced wetting of the second set of additives, may make the use of a coating on the filler material obsolete. When the filler material, more particularly said calcium carbonate in said filler material, is coated, this preferably concerns a coating or surface treatment with a stearate.

In a special preferred embodiment, said PVC composition comprises recycled PVC, wherein said secondary blend further comprises a portion of said recycled PVC, wherein preferably said primary blend is free of recycled PVC, or, wherein said primary blend comprises 10 wt % or less of said recycled PVC. Preferably, said recycled PVC which is added to said secondary blend has a particle size distribution with a D 90 value of 500 μm or less. The recycled PVC may be obtained as industrial, post-industrial or post-consumer waste. It may for example concern dust obtained from sawing or milling previously obtained board or sheet materials, through a same or similar method.

With the same aim as in said first in dependent aspect, the present invention, in accordance with its second independent aspect is a method for manufacturing a board or sheet material, whether or not in accordance with said first independent aspect and/or the preferred embodiments thereof, wherein said board or sheet material at least comprises a layer of polyvinyl chloride comprising filler material, wherein said method comprises at least the following steps:
the step of compounding a PVC composition;
the step of extruding said PVC composition using an extruder having at least one screw, and a slot nozzle die linked to the outlet of said extruder;
   with as a characteristic that said PVC composition at least comprises glass beads, nitrile rubber, oxidized polyethylene wax, a gelification agent, and/or epoxidized soybean oil (ESBO). Preferably, said PVC composition is free of further plasticizing agents or comprises further plasticizing agents at a rate of 5 phr or less, in other words, the PVC composition is preferably for extrusion of a board or sheet material comprising at least a layer of rigid PVC.

The use of glass beads may lead to a diminished wear on the extruder barrel and/or screw. Nitrile rubber, oxidized polyethylene wax, epoxidized soybean oil and other gelification agents may also provide a plasticization effect which leads to an easier transport through the extruder, and/or to a more dense PVC composition that requires less compression in the extruder. The lesser compression may in itself yield a lower extruder wear, and/or a higher extruder output or speed.

Said glass beads, nitrile rubber, oxidized polyethylene wax, a gelification agent, and/or epoxidized soybean oil may be added to said primary blend and/or to said secondary blend, while practicing a two substep compounding as disclosed in connection to the first independent aspect and/or the preferred embodiments thereof. In the context of the second independent aspect of the present invention, namely with the use of nitrile rubber, oxidized polyethylene wax, epoxidized soybean oil, and/or another gelification agent in the PVC composition, it is however possible to apply a single step compounding, wherein the PVC, all additives, including said nitrile rubber oxidized polyethylene wax, epoxidized soybean oil and/or another gelification agent, and at least 30% of the filler materials, but preferably all or substantially all of the filler materials, are mixed in a hot-and-cold-mixer. The remaining portion of the filler material can be added subsequently to the obtained mixed blend. Due to the gelification agent, the nitrile rubber, the oxidized polyethylene wax and/or the epoxidized soybean oil a relatively dense PVC composition can be obtained, that requires less compression in the extruder.

With the same aim as in said first and second dependent aspect, the present invention, in accordance with its third independent aspect is a method for manufacturing a board or sheet material, whether or not in accordance with said first and/or said second independent aspect and/or the preferred embodiments thereof, wherein said board or sheet material at least comprises a layer of polyvinyl chloride comprising filler material, wherein said method comprises at least the following steps:
the step of compounding a PVC composition;
the step of extruding said PVC composition using an extruder having at least one screw, and a slot nozzle die linked to the outlet of said extruder;
   characterized in that said step of compounding comprises transporting a PVC blend by means of a rotary vane vacuum pump. The use of a rotary vane vacuum pump may yield a particularly dense PVC composition, with a low risk of contaminating the PVC composition or PVC blend being transported. The obtained PVC composition may require less compression in the extruder. Preferably, said PVC blend at least comprises PVC, impact modifier and possibly filler materials. Preferably, said PVC blend is a primary blend or a secondary blend as described in connection to said first independent aspect and/or the preferred embodiments thereof.

It is clear, with reference to the first till third independent aspect, that said step of extruding said PVC composition at least provides for said layer of polyvinyl chloride comprising filler material to be extruded through said slot nozzle die. It is not excluded that one or more further layers of the board or sheet material are extruded through the same or through a different die, whether or not on the basis of a PVC composition that has been compounded in a similar or identical manner as described in connection to any of the first till third independent aspect of the invention and/or the preferred embodiments thereof.

In general, said layer of polyvinyl chloride comprising filler material preferably forms at least half of the thickness of said board or sheet material or at least 75% or at least 95% of said thickness of said board or sheet material. Said layer of polyvinyl chloride may form the entire thickness, nearly or about the entire thickness of said board or sheet material.

Preferably, the board or sheet material has a thickness of 2 to 7 mm, more preferably of 2.8 to 5 mm. The width of the board or sheet material may be from 1 to 2.5 m, preferably from 1.25 to 2.15 m. The board or sheet material is preferably initially provided as an endless material, and later on divided both in width and length directions.

It is further noted that the present invention also is a method for manufacturing decorative panels, with the characteristic that said method at least comprises manufacturing a board or sheet material in accordance with any of the first, second and/or third independent aspects and/or the preferred embodiments thereof, and applying a decorative top layer on said board or sheet material to yield a decorated board or sheet material. Preferably, said method further comprises dividing said decorated board or sheet material into panels having at least approximately the dimensions of the decorative panels to be obtained, and further finishing said decorative panels. Said further finishing may comprise shaping, e.g. through milling, one or more edges of said panels, for example in order to create profiled edges wherein at least two opposite edges of said panels are provided with profiled edges comprising coupling parts allowing two such panels to become coupled, wherein in a coupled condition the respective edges are locked to each other in a direction perpendicular to the plane of the panels and in a direction in said plane and perpendicular to the respective edges.

Said decorative top layer may comprise a printed pattern and a transparent or translucent wear layer applied over said printed pattern. The printed pattern may be provided by directly applying inks on said sheet or board material, preferably with the intermediate of one or more primer layers. Alternatively, said printed pattern may be provided by application of a preprinted foil on said sheet or board material, preferably by thermal lamination. Said preprinted foil may be a printed thermoplastic foil, such as a printed PVC foil. The transparent or translucent wear layer may comprise PVC and/or a layer of urethane, urethane acrylic or acrylic lacquer. The transparent or translucent wear layer may be applied as a prefabricated sheet, e.g. by thermal lamination, and/or by direct liquid applicant, for example via roller coating, of the respective material, e.g. PVC and/or lacquer.

The transparent or translucent wear layer may be provided with a texture, for example by means of a mechanical embossing treatment.

In general it is remarked that, wherever for a particle size distribution D90 values are described herein, the particle size distribution may be measured by various techniques known in the art. Particularly, the particle size distribution may be determined by laser granulometry, in particular, the particle size distribution may be determined using laser granulometry, which may be performed in accordance with ISO 13320:2020. This is a dynamic light scattering technique using a laser with an emission wavelength of 632.8 nm, measuring at a scattering angle of 90 degrees. This technique may be performed, for example, with a Malvern® Mastersizer 2000 or with a Malvern® Mastersizer 3000. To perform the measurement of the particle size distribution, the respective particles need to be brought in a loose state, and can be dispersed in a liquid, such as water.

The present invention is not limited to the preferred embodiments described here above, but such methods and sheet or board materials may be realized according to several variants without leaving the scope of the invention.

1.-15. (canceled)

16. A method for manufacturing a board or sheet material, wherein said board or sheet material at least comprises a layer of polyvinyl chloride comprising filler material,
wherein said method comprises at least the following steps:
the step of compounding a PVC composition;
the step of extruding said PVC composition using an extruder having at least one screw, and a slot nozzle die linked to the outlet of said extruder;
wherein said step of compounding comprises at least a first substep wherein a primary blend of PVC and a first set of additives is created,
wherein said primary blend is free of filler material, or,
wherein said primary blend comprises 10 wt % or less of said filler material, and, at least a second substep wherein a secondary blend is created comprising at least said primary blend, a second set of additives and a portion of said filler material,
wherein said PVC composition comprises or consists of said secondary blend.

17. The method of claim 16, wherein said first set of additives comprises at least an impact modifier and/or a foaming agent.

18. The method of claim 16, wherein said second set of additives comprises at least stabilizer and/or a wax.

19. The method of claim 16, wherein said primary blend and said secondary blend are created in a hot-and-cold mixer.

20. The method of claim 16, wherein said PVC composition and/or said secondary blend comprises 50 to 90 wt % of filler material.

21. The method of claim 16, wherein said filler material comprises calcium carbonate and/or talcum.

22. The method of claim 21, wherein said filler material comprises 1 to 15 wt % of talcum, while the remaining portion of said filler material comprises 80 to 99 wt % of calcium carbonate.

23. The method of claim 21, wherein said calcium carbonate is free of coating, or coated with a stearate.

24. The method of claim 16, wherein said PVC composition comprises recycled PVC,
wherein said secondary blend further comprises a portion of said recycled PVC,
wherein said primary blend is free of recycled PVC, or,
wherein said primary blend comprises 10 wt % or less of said recycled PVC.

25. The method of claim 24, wherein said recycled PVC which is added to said secondary blend has a particle size distribution with a D90 value of 500 μm or less.

26. A method for manufacturing a board or sheet material, whether or not in accordance to claim 16,
wherein said board or sheet material at least comprises a layer of polyvinyl chloride comprising filler material,
wherein said method comprises at least the following steps:
the step of compounding a PVC composition;
the step of extruding said PVC composition using an extruder having at least one screw, and a slot nozzle die linked to the outlet of said extruder;
wherein said PVC composition at least comprises glass beads, nitrile rubber, oxydized polyethylene wax, a gelification agent, and/or epoxidized soybean oil (ESBO).

27. The method of claim 26, wherein said PVC composition is free of further plasticizing agents or comprises further plasticizing agents at a rate of 5 phr or less.

28. A method for manufacturing a board or sheet material, whether or not in accordance with claim 16,
wherein said board or sheet material at least comprises a layer of polyvinyl chloride comprising filler material,
wherein said method comprises at least the following steps:
the step of compounding a PVC composition;
the step of extruding said PVC composition using an extruder having at least one screw, and a slot nozzle die linked to the outlet of said extruder;
wherein said step of compounding comprises transporting a PVC blend by means of a rotary vane vacuum pump.

29. A method for manufacturing a decorative panels, wherein said method at least comprises manufacturing a board or sheet material in accordance with claim 16, and applying a decorative top layer on said board or sheet material to yield a decorated board or sheet material.

30. The method according to claim 29, wherein said method further comprises dividing said decorated board or sheet material into panels having at least approximately the dimensions of the decorative panels to be obtained, and further finishing said decorative panels.
